(19) United States
(12) Patent Application Publication
(10) Pub. No.: US 2008/0013700 A1
(43) Pub. Date: Jan. 17, 2008

(54) Method and system for providing consumer opinions to companies

(76) Inventor: Darko Butina, Ljubljana (SI)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/784,814

(22) Filed: Apr. 10, 2007

Related U.S. Application Data
(60) Provisional application No. 60/799,112, filed on May 10, 2006.

(51) Int. Cl. H04M 11/00

(52) U.S. Cl. 379/92.01; 455/466

(57) ABSTRACT

Method and system for accepting, handling and distributing opinions and feedback to any entity, company or institution from any customer or user. Opinions can be sent through various communication channels such as mobile phones, SMS messaging systems, other mobile devices, PC (internet), phones and the like. The system enables two-way communication between companies and users while users remain anonymous towards companies. Opinions are handled in accordance with locations for which they are sent for, in accordance with user information and in accordance with communication channel they were sent through. Users can send their opinions in the same manner for all companies and institutions, which means that the system presents one-point stop for all opinions users want to communicate to various companies. Two-way communication which is possible with the use of the system also gives companies additional value for their customer relationship management.

### RELATED APPLICATION(S)

This application claims the benefit of U.S. Provisional Application No. 60/799,112, filed on May 10, 2006. The entire teachings of the above application(s) are incorporated herein by reference.

### BACKGROUND OF THE INVENTION

Every company faces harsh competition, especially since business has truly become global. And an important advantage for each company is the right information at the right time, because only such information enables companies to react quickly and correctly in order to beat their competition, be successful and sometimes even to enable them to exist. Such information consists of many pieces and is gathered in many different ways. And market research presents an important way to gather such information. Among different methods of market research, one is of particular importance for companies, consumer feedback. A company sells to its consumers and its success depends on its consumers. Feedback information is usually gathered directly by the company from its consumers. Information is gathered by follow-up activities such as phone surveys, questionnaires (by mail, internet, mobile devices, post, with people doing the interviewing), directly by the employees in the shop, office etc. and of course by offering different communication channels to customers to enable them to share their opinions with the company.

Researches (such as by the US White House Office of Consumer Affairs) show that 96 percent of unsatisfied customers never complain and that 90 percent of these customers never return for the next purchase. Therefore it is of vital importance for companies to gather as much feedback information as possible. If companies gather data directly from the customers they are not anonymous (even if the company tells them so—direct contact can never be completely anonymous), they have to use a different way of contacting for each different company (different e-mail and web addresses, different 800 phone numbers etc.), their opinions may remain with the shop employee only and do not get forwarded to management (because the employee does not want his / her boss to know about his/her incompetence) and no actions can be taken regarding these opinions.

Companies also strive to use their marketing funds efficiently, which means that they are carefully planning and choosing appropriate media which enables them as direct approach as possible to their consumers (or potential consumers). Usually marketing activities are targeted to secondary criteria such as specific population groups based on their age, gender etc. Companies use these secondary criteria to target the people who are likely to buy (or are already buying) their products and services, because companies usually do not have information which would enable them to efficiently market their products and services only to people who would potentially be interested to buy their products and/or services (this is primary criteria).

Since information is of vital importance in today's business world, additional information about specific industries helps companies make right decisions. That is, companies not only gather information about their own services and/or products, but also need to know what their competition does, what is their position in their industry etc.

Mobile phones and devices are already well established communication means in today's society. Particularly GSM (Group Special Mobile—global system for mobile communication) and also SMS (Short Message Service) technology is gaining importance as it is being more widely accepted around the world (especially in the USA). The main advantage of such mobile communication is that consumers carry their mobile devices almost everywhere they go and are also used to using them almost everywhere they are.

### SUMMARY OF THE INVENTION

A system for forwarding opinions offers consumers a one-point-stop through which they can send their opinions in the same manner to any company/entity while remaining anonymous to companies, without the need to remember several different ways of communication with any company (one and the same way of communication is sufficient), while being aware that opinions are being forwarded to appropriate addresses in the companies (to people who can make the difference, who are in a position to act upon the received opinion). Combined with other business incentives (partner companies' benefits for users, awards for using the system etc.) users have access to a communication channel which is easier to use, is efficient and enables them additional benefits simply by its usage.

The system for forwarding opinions enables companies to directly target their potential and existing consumers. It namely classifies users according to their preferences and some preferences are attributed to users according to which locations/companies their opinions were meant for.

The system also enables basic analysis of opinions, which can be used to provide reports on specific industries.

Benefits and advantages of the present invention thus include:

1. One point stop for customer opinions and feedback—all consumers can send their opinions through the system for any company or entity in the same manner

2. Automatic reply—the system automatically sends the appropriate auto-reply for each opinion sent over the system. Answers are automatically selected on the basis of customer's status (registered or not), company unit for which the opinion is meant, status of the company (partner company or not), possible benefits (answer includes a benefit or not) and optional need for obtaining specific additional information.

3. Multiple communication channels—system supports multiple communication channels such as SMS (GSM), web and computerized voice recognition. These communication channels all offer easy to use and accessible technology, two-way communication and also offer some sort of unique user identification (phone number, e-mail address).

4. Automatic distribution of opinions—system automatically recognizes keywords in SMS messages, selected partner companies/entities from web lists or keywords recognized by voice recognition. According to these keywords, the system automatically distributes by e-mail opinions to companies/entities they were sent for.

5. Anonymity—all data which identifies the user (and which is not part of user's opinion), such as phone number, e-mail address etc., is identified by the system with unique user ID number. As such the user remains anonymous while ID number enables companies/entities to get information, which opinions are sent by the same user (thus efficiently helping to monitor and stop any possible abuses) and it also enables the two-way communication between companies and users.

6. Benefit delivery—users can receive benefits from companies to which they send their opinions (and also from other partner companies). Since these benefits typically include some sort of coupon for additional discount or free service or product, users receive mobile coupons over SMS messages, which enable them to use the benefits wherever they are, simply by showing the SMS message containing the benefit at for example cashiers in the shop.

7. Assigning preferences to users—every user is assigned preferences on the basis of his/her opinions. Every opinion by the user is intended for specific location of the company or at least for specific company. Since industry of the company and also of the location can be easily identified, this information is always logged together with other data for specific location or company. According to intended “destination” for user's opinion, user's preferences are updated with appropriate preference/preferences. The system also supports multiple preferences assignations.

8. Evaluation marks—the system can be adapted to enable usage of evaluation marks together with unstructured opinions. These marks are used to produce automatic quality analysis of specific locations/companies/entities/brands/services/products.

9. Analysis of received opinions—system enables half-automatic analysis of received opinions and therefore enables quick and effective production of reports on received opinions. Every opinion is first automatically defined by the system on the basis of the keyword the opinion has (this defines location/company). Then the opinion is defined by a system administrator on the basis of the content of opinion and may include defining several parameters such as positive/negative, content definition (predefined categories) etc. This then enables production of automatic qualitative analysis of received opinions.

10. Real-time delivery of opinions/feedback—every opinion is automatically forwarded to an appropriate company/entity e-mail address on the basis of the keyword it includes. If the system does not recognize the keyword, the system administrator checks the opinion and defines it with correct keywords so that the opinion can be then processed and forwarded automatically.

11. Location specific notification materials—the system uses for each specific location individually prepared materials (especially for the SMS and VR communication channel). These materials contain unique keywords which identify specific locations and can be obtained/viewed only on the spot (meaning in specific store, office etc.). This ensures correct automatic forwarding of opinions.

12. Relevant date and time information—whenever opinions are sent on the basis of keywords noted on the notification materials, date and time information of the sent opinion present added value information for the company/entity. Such keywords are only stated in the “on the spot” notification materials which means that such opinions were sent directly from a specific company location. And with the relevant date and time information this means companies know not only for which location they received the opinion but possibly also for which employee.

13. Two-way communication—system enables two-way communication between users who send opinions and companies which receive opinions. The system guarantees anonymity for users while enabling two-way communication between them and the companies by assigning uniquely identifiable ID numbers to users. These ID numbers can be used by companies for two-way communication and notifying users of actions taken on the basis of their opinions.

14. Obtaining specific additional information—the system not only receives and forwards opinions but is also able to obtain additional specific information by posing appropriate questions to users. This means that when the user sends his opinion the system assigns the opinion to the appropriate location/company. Then, if such functionality is chosen, the system selects an appropriate question (for example, if the opinion is intended for a specific product, the question can be where did the customer buy this product) and receives the user's appropriate answer. Whether the question is posed to the consumer user or not can depend on different criteria (location, location's industry, date, time, mobile operator, region etc.).

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 depicts a preferred embodiment of the opinion forwarding system in accordance with the present invention;

FIG. 2 depicts a flow chart of the opinion forwarding process in accordance with the principles of the present invention.

FIG. 3 is a block diagram of a computer node for executing embodiments of the present invention.

### DETAILED DESCRIPTION OF THE INVENTION

A description of preferred embodiments of the invention follows.

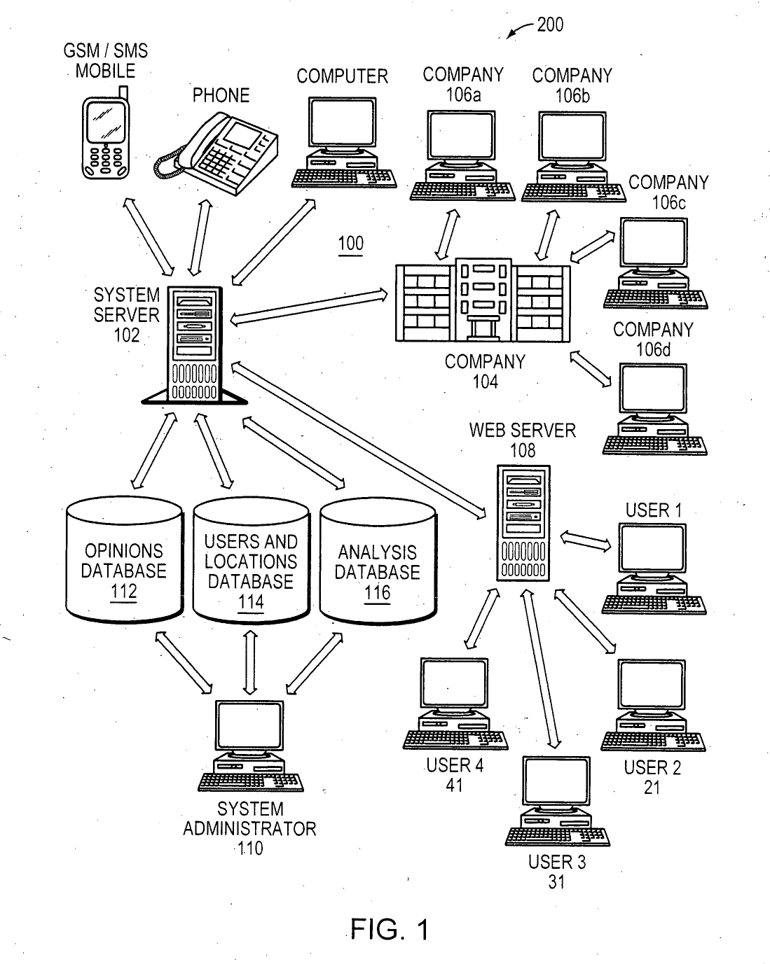

As depicted in FIG. 1 the present invention system 200 comprises the following elements: communication channels 100, a system server 102 (and corresponding company 104), data stores 112, 114, 116 and a Web server 108. The various communication channels 100 such as mobile devices (GSM, SMS messaging enabled devices, handhelds etc.), phones, computers, post etc. enable consumer users to send their opinions to the invention system as shown at 100. The system server 102 together with appropriate application(s) enables forwarding of received opinions to appropriate user (consumer) intended companies 106 and two-way anonymous communication between users and these companies. At server company 104 opinions are forwarded to appropriate companies 106, institutions and even individuals/persons. A web server 108 enables dynamic display of opinion analysis summaries to interested end users 21, 31, 41. System server 102 also attributes opinions to users and locations (companies 106), and analyzes the data. System server 102 stores the data in appropriate databases 112, 114, 116 managed by the system administrator 110.

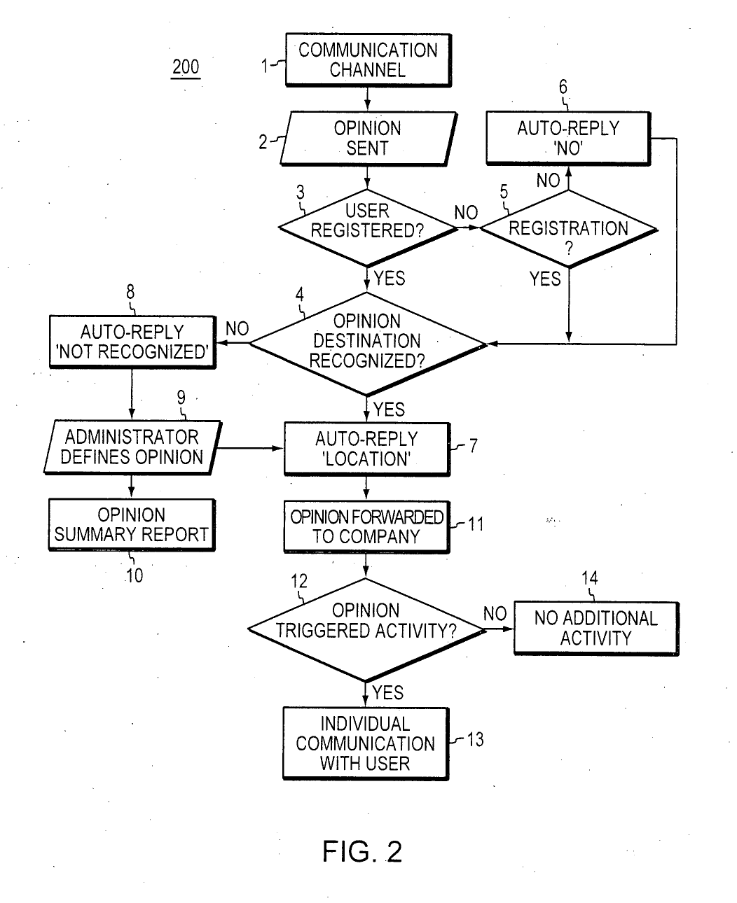

Referring to FIG. 2, there is depicted a flow chart of the opinion forwarding process in accordance with the principles of the present invention. A consumer user makes use of various communication channels 1 to send opinions 2 through the invention system 200. In order to ensure relevant opinions, consumer users have to be registered to gain access to all functionalities of the invention system 200. The system 200 thus checks if the user is already registered 3 and if not, registration is demanded 5. The user can also decide not to register and receives an appropriate auto-reply 6, however he then does not gain access to all benefits of the system 200. In that case, only basic functionality is provided meaning his opinion gets forwarded to the appropriate (his intended) company 106.

In order to properly forward the opinion, the system 200 checks whether the opinion destination (the company 106 for which the opinion is meant) is recognized 4. The system 200 recognized destination 106 by verifying opinion specific keywords or other appropriate attributes with users and locations database 114 (example: when sending SMS opinions, destination is specified with a specific short nickname—keyword, such as COMP01, which specifies exact specific destination of specific company—other keywords for the same company can be i.e. COMP02, COMP03 etc.; same principles apply for other communication channels). This enables the system to forward opinions at step 11 to a variety of (plural) companies 106 and also a variety of (plural) locations for specific companies. If the destination (location) is not recognized at step 4, then the consumer user gets appropriate notification 8 and the opinion is forwarded to administrator 110. The administrator 110 in turn defines the opinion 9 and the system sends to the intended company 106 an appropriate notification which is connected with specific company location 7. If the opinion destination is recognized by the system 200 itself, the system 200 transmits to target company 106 the appropriate notification immediately 7. As soon as the opinion destination (location) is known by the system, the system 200 translates the subject opinion into respective target company format and forwards the message to the appropriate company 11. Subscribing/participating companies 106 also have the option to use the system 200 to reply to specific consumer users and their opinions 13, especially in case the company undertook specific activities on the basis of received opinion 12. In one embodiment, when the system 200 receives a reply from the target company and delivers the reply to the consumer 13, system 200 maintains anonymity of the consumer with respect to the target company.

System/process 200 may include various reporting 10, 14 such as administrator 110 opinion summary reports 10. Other reporting is suitable and in the purview of one skilled in the art.

The system 200 enables consumer users to send their opinions to a variety of (plural) companies or institutions in the same manner. If different company formats exist among the plural companies, system 200 translates the input message (consumer opinion) into respective formats for delivery to the different target companies. Therefore the system 200 functions as one point stop for all opinions users want to send to any company or institution. The system 200 as such efficiently eliminates the need for the user to remember specific contact information and message format for each company and can instead use the same one system 200 to send his opinions to various companies. Together with enabled two-way communication between consumer users and companies 106, the system 200 is easy to use for consumer users and companies and gives companies valuable additional value for their customer relationship management.

The system 200 uses electronic communication channels 100 as primary means since they enable efficient, fast and easy to use two way communication. Especially useful is the use of the invention system 200 in connection with the GSM/SMS message communication channel. Because GSM phones are becoming more and more widespread (in EU practically everybody has them and in the USA the use of GSM phones rises dramatically from month to month), all have the functionality of SMS messaging built in, are mobile and can be used practically anywhere (especially in urban areas). With the use of a GSM/SMS message communication channel, opinions are already saved in electronic form which enables easier and faster handling, forwarding and analysis of received opinions. Another advantage of this communication channel is immediate establishment of two-way communication with SMS messages being sent in near real-time. Thus replies from the system 200 and companies 106 have much greater impact on users who receive them.

Every user who uses the system 200 is identified. If users use GSM/SMS message communication channel, they are identified by their phone numbers, if they use internet communication channel, they have to register and are identified by their e-mail address (and if possible by their phone numbers—this enables the system 200 to truly uniquely identify specific user and his opinions which were sent through various communication channels 100). If the consumer sends opinions by postal mail, he has to identify himself with his address, phone number or e-mail address, etc. This GMS/SMS phone number or email identification is used for the purpose of establishing two-way communication between companies 106 and users, and it is not disclosed to companies. Every user is given his own unique identification number and this identification number is then used to route all opinions from user to companies 106 and to route all replies from companies 106 to user.

In the system 200, system server 102 has appropriate Internet connection and a specifically developed software application for the present invention. This application consists of two parts: application and admin part. The system 200 and its application work with a data store which can be generally divided into three major parts: opinions database 112 (all received consumer opinions and information relating to these opinions are logged in this database), users and locations database 114 (this database logs consumer users and their registration statuses, has a list of company locations and is linked with opinions databases 112), and analysis database 116 (opinions are analyzed in such a way that characteristics of opinions are chosen, such as positive/negative, talking about personnel, hygiene, work process organization etc.—this database stores results of such analysis, has lists of possible characteristics to choose from and is linked with opinions and users and locations databases 112, 114). The invention application ensures appropriate handling of received opinions, including the identification of opinion destination (location), substituting user identification data with unique identification number from database 114 (thus ensuring anonymity of the user towards companies), handling of two-way communication with appropriate replies and appropriate selection of reply communication channel (different opinions and different situations require different replies, different replies require appropriate selection of various communication channels).

Invention system 200 normally forwards the consumer input opinions by e-mail to appropriate addresses in companies 106. These addresses are designated by the company 106 upon subscription to the invention system or by the company 106 per published company information. Opinions have thus direct impact on the quality of services and products (opinions are forwarded to company employees who are in a position to act). Communication between the system 200 and the companies 106 is through e-mail (directly to addresses specified by companies) and over the Internet (through admin interface secured with username and password).

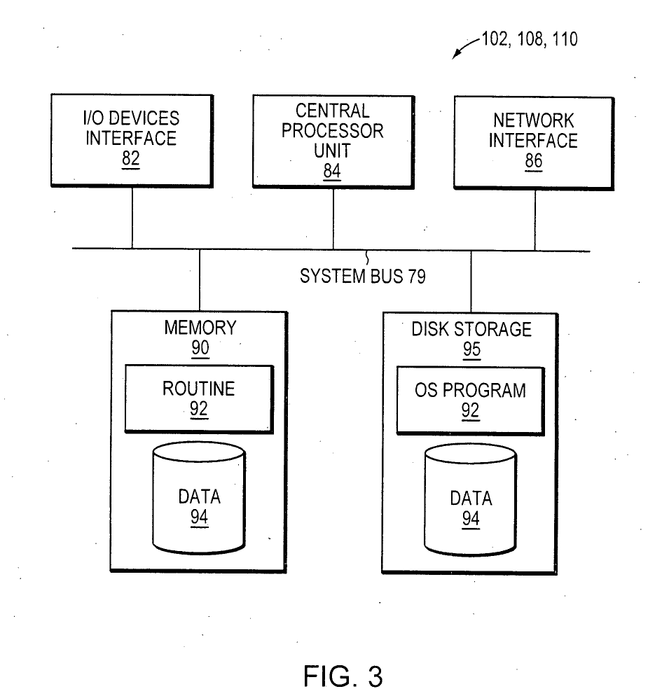

FIG. 3 is a diagram of the internal structure of a computer (e.g., system server 102, web server 108, administrator client 110) in the opinion forwarding system 200 of FIG. 1. Each computer 102, 108, 110 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 102, 108, 110. Network interface 86 allows the computer to connect to various other devices attached to a network (e.g., global computer network). Memory 90 provides volatile storage for computer software instructions 92 and data 94 used to implement an embodiment of the present invention (e.g., process 200 detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 102, 108, 110 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

While this invention has been particularly shown and described with references to preferred embodiments thereof, it will be understood by those skilled in the art that various changes in form and details may be made therein without departing from the scope of the invention encompassed by the appended claims.

For example, the foregoing states “opinions” which may include feedback, user input, or other messages. Also the term “company” used herein may be any institution, organization or entity, whether commercial or not for profit. The method and system for opinion forwarding disclosed herein includes accepting, handling, distributing and other processing of such (opinions, feedback, messages and the like). The term “consumer” is intended to include customer, interested person, user and the like.)

What is claimed is:

1. In a computer network, a consumer-to-company messaging system, comprising:
a server receiving as input a message from a consumer indicated as intended for at least one target company, the server being responsive to the received message, anonymizing the message and forwarding the anonymized version of the message to the target company by email; and
a data store holding email addresses of a plurality of companies, the server obtaining from the data store email address of the target company.

2. A messaging system as claimed in claim 1 wherein the received message is an opinion by the consumer, and the email address of the target company used by the server is a pertinent company location that handles customer opinions.

3. A messaging system as claimed in claim 1 wherein the consumer inputs to the server different messages for different target companies, the server enabling the consumer to effectively have a single system for communicating messages to different companies.

4. A messaging system as claimed in claim 3 wherein if different company formats exist among the target companies, the server translates the input message into respective formats for delivery to the different target companies.

5. A messaging system as claimed in claim 1 wherein the server receives a reply from the target company and delivers the reply to the consumer, enabling two-way communications between the target company and consumer while maintaining anonymity of the consumer with respect to the target company.

6. A messaging system as in claim 1 wherein the input is transmitted to the server from the consumer by any of phone, messaging device, mobile device and computer.

7. A computer implemented method for consumer-to-company messaging, comprising:
receiving as input a message from a consumer and indicating at least one target company;
anonymizing the message; and
forwarding by email a resulting anonymized version of the message to each indicated target company; said forwarding by email including obtaining from a data store a respective email address of each target company.

8. The method of claim 7, wherein:
the received message is an opinion by the consumer; and
for each target company, the respective email address is a pertinent company location that handles customer opinions.

9. The method of claim 7 wherein the input from the consumer is different messages for different target companies.

10. The method of claim 9 further comprising:
if different company formats exist among the different target companies; then translating the input messages into respective formats for delivery to the different target companies.

11. The method of claim 7 further comprising receiving a reply from the target company and delivering the reply to the consumer, enabling two-way communications between the target company and consumer while maintaining anonymity of the consumer with respect to the target company.

12. The method of claim 7 wherein the input is transmitted from the consumer by any of phone, messaging device, mobile device and computer.

13. Opinion forwarding apparatus comprising:
computer server means responsive to input received from a consumer, the input including an opinion by the consumer and an indication of one or more target companies, the server means forming an anonymized form of the opinion and
email means enabling the server means to provide the anonymized form of the opinion by email to each indicated target company, the email means including means for obtaining respective email addresses of indicated target companies.

14. Apparatus as claimed in claim 13 wherein the means for obtaining respective email addresses provides, for each target company, pertinent company location that handles public opinions.

15. Apparatus as claimed in claim 13 wherein the consumer inputs different messages for different target companies, the server means enabling the consumer to effectively have a single system for communicating messages to different companies.

16. Apparatus as claimed in claim 15 further comprising translation means in cooperation with the server means, if different company formats exist among target companies, the translation means translates the anonymized form of the opinion into respective formats for delivery to the different target companies.

17. Apparatus as claimed in claim 13 wherein the server means receives a reply from any target company and delivers the reply to the consumer, enabling two-way communications between the target company and consumer while maintaining anonymity of the consumer with respect to the target company.

18. Apparatus as claimed in claim 13 wherein the input is provided by the consumer by any of phone, messaging device, mobile device and computer.

19. Computer program product comprising:
a computer usable medium having computer usable program code for handling consumer-to-company feedback, including:
computer useable program code for receiving input from a consumer, the input indicating a target company and including a message intended for the target company;
computer usable program code for anonymizing the message; and
computer usable program code for electronically communicating the anonymized message to the target company.

20. Computer program as claimed in claim 19, wherein the input from the consumer is different messages for different target companies; and
if different company formats exist among the different target companies, then further computer usable program code for translating the input messages into respective formats for delivery to the different target companies.
